(19) United States
(12) Patent Application Publication
(10) Pub. No.: US 2004/0036710 A1
(43) Pub. Date: Feb. 26, 2004

(54) Method for creating and outputting a document

(76) Inventor: Hartwig Schwier, Munchen (DE)

Correspondence Address: SCHIFF HARDIN & WAITE, 6600 SEARS TOWER, 233 S WACKER DR, CHICAGO, IL, 60606-6473, US

(21) Appl. No.: 10/240,294

(22) PCT Filed: Apr. 9, 2001
(86) PCT No.: PCT/EP01/04059

(30) Foreign Application Priority Data
Apr. 11, 2000 (DE) 100 17 892.8

(51) Int. Cl. G09G 5/00

(52) U.S. Cl. 345/700

(57) ABSTRACT

The invention relates to a method for creating and outputting at least one document. A document comprising at least one printed page is created using a creating program module. The document contains first image data of image elements. A representation parameter which determines an outputting parameter set is assigned to sections of the document respectively. An outputting unit outputs image elements on the basis of second image data. The image characteristics of these image elements are determined using the outputting parameter set. A control program module for controlling the outputting unit process second image data from the first image data in a sectional manner according to the outputting parameter set of the outputting unit. The representation parameter selects outputting parameters from a plurality of possible outputting parameters for this outputting unit.

The invention is directed to a method for creating an outputting at least one document. A document having at least one print page is created with the assistance of a creation program module. The document contains first image data of picture elements. On the basis of second image data, an output unit outputs picture elements whose image properties are defined by an output parameter set. The output unit outputs the document with the image data adapted to the output parameter set. The invention is also directed to a computer program as well as to a system for the implementation of the method.

In data processing systems, image data of print pages are output on output units, for example on picture screen and on printers. The image data of print pages are created with the assistance of a creation program module, for example with a text processing program, with a forms editor or with a desk top publishing program module (DTP program module). These image data must be converted for the output of the image data so that the respective output unit can process these data. This conversion is implemented, for example, with the assistance of a print driver program module given output of the print page by a printer or with the assistance of a picture screen driver program module given output of the print page on a display unit. Print driver and picture screen driver program modules are also referred to as drive program modules.

Upon conversion, the image data are converted such into second image data according to the output parameter set prescribed by the drive program module that these second image data correspond to the output parameters of the preset output parameter set. The output parameter set contains, for example, the outputs parameters resolution and color depth of the output unit.

A output parameter set of the printer can be pre-set for all print pages to be printed in the printer driver program module. The pre-setting preferably ensues in forms of the printer driver, what are referred to as register cards of the printer driver. Standard parameters such as, for example, the contrast, the brightness, a reduction of the possible output resolution of the printer, the paper feed, the desired color mixing and the desired printing density can thereby be pre-set. Dependent on the printer type, setting for activating duplex printing methods, for activating color printing as well as for color matching are also possible.

The print pages of the document can have been created from different kinds of picture elements that make different demands of the output parameters of the output unit. For example, the Prior Art discloses printer drivers wherein an output parameter set for a print job can be set, i.e. the output parameters can be uniformly set for the entire document. A print job is thereby the instruction to output one or more print pages of a document with the pre-set output parameter set on a selected printer. When picture elements that make especially high demands of the output parameters of the selected printer in view of the image quality are to be output on one of the print pages of the document, these complex print parameters are pre-set for the entire print job, for example in forms of the printer driver. The remaining picture elements of the print job, for example picture elements that contain text, are output with the same special output parameters, even though simple output parameters suffice for the presentation of these picture elements in order to present them with high quality. In the Prior Art, thus, the print pages of a document that contain only picture elements that require no complex output parameters are output in a separate print job with correspondingly simple, pre-set output parameters. For example, the picture elements are output monochromatically black with a resolution of 300 dots per inch (dpi). The pages of the document that contain picture elements that require complex output parameters are output in a further print job. Output parameters are thereby pre-set that are required for the output of these picture elements. Thus, these pages that contain complex picture elements are output, for example, in a color print with a color depth of 4 bits (16 colors) and a resolution of 600 dpi. A performance-adapted output of the picture elements is not possible.

German Patent Applications DE 199 11 462.5, DE 199 11 461.7 and 100 17 893.3 (applicant's reference: 2000-0408DE) disclose printer drivers for high-performance printing systems. These three patent applications as well as the PCT applications parallel therewith are herewith incorporated by reference into the present specification. EP 0 971 309 A2 discloses a method and a system with which documents that contain various elements can be output to a printer with controlled parameters.

An object of the invention is to create a possibility of outputting picture elements of print pages performance-adapted with a print job as well as to individually adapt the image data of picture elements for the output on an output unit such that a qualitatively high-grade appearance derives for the viewer.

This object is achieved by a method having the features of patent claim 1. Advantageous developments of the invention are recited in the dependent claims.

By allocating a presentation parameters to respectively one section of the document, it is possible to output the sections of the document with the output parameter set that is allocated to the respective presentation parameter. The allocation of the presentation parameters to the output parameter sets can be pre-set, for example, in the drive program module. Individual sections of documents can thus be output performance-adapted by means of the allocation of a respective presentation parameter set, since the output of picture elements with simple output parameters saves time and consumables and, thus, costs as well. Further, the assistance of the presentation parameters makes it possible to individually adapt the image data of the sections of the document. The pre-settings of the output parameters also particularly comprise the color depth, the color allocation as well as further parameters that define the color space of the image data to be presented in the conversion of the image data.

For example, the image processing procedures of known printer driver program modules are used for the conversion.

In one embodiment of the invention, the allocation of the presentation parameters ensues page-by-page. What is thereby achieved is that the allocation of the presentation parameters need not ensue in the creation program module. The allocation of the presentation parameters can ensue with the assistance of a further program module, for with the assistance of the drive program module. A simple possibility is thus established of also applying the inventive method given existing creation program modules wherein an integration of the inventive method is not possible with reasonable outlay. The positions of the page breaks of the print pages are usually also transmitted by creation program modules in the transmission of image data, for example upon transmission to drive program modules, so that a page-by-page allocation of the presentation parameters by program modules other than the creation program module is also possible in an uncomplicated way. For example, the creation program module can thereby be a known text processing program module, a DTP program module or a forms generator.

In a development of the invention, the assistance of the presentation parameters also makes it possible to automatically output the print pages on different output units dependent on the presentation parameters, said different output units potentially having different output parameters. As a result thereof, it is possible to output the print pages of a document whose picture elements require only simple output parameters, i.e. less significant output parameters, on a printer that is suitable for the output of these picture elements. The print pages having complex picture elements, i.e. more significant picture elements, are output with the assistance of a further printer that has correspondingly more significant output parameters. Cost-beneficial printing methods can thus be realized in a simple way for outputting print pages having different demands made of the output parameters of the printers.

It is also advantageous to create the print pages with the assistance of a first computer unit and to output them at a far later time with the assistance of an output unit connected to a second computer unit. The inventive allocation of the respective presentation parameters can ensue in this second computer unit, for example by means of inputs by an operator.

According to the features of claim 14, a computer software is recited that comprises commands and data that, following the loading of the computer software, initiate a data processing system or, respectively, a computer system to execute the steps cited in one of the method claims. What is thereby achieved is that the inventive method is executable with the assistance of a computer system. It is advantageous to store this computer software on a storage medium in order to process it is data processing systems.

Further, a system having the features of claim 16 is recited that implements the inventive method. Such a system is preferably a data processing system or, respectively, a computer system. Print pages can be created with such a system, whereby the image data of sections of this print page are output with different output parameters in a print job.

Further features and advantages of the invention derive from the following description, which explains the invention on the basis of an exemplary embodiment in conjunction with the attached drawings. Shown are:

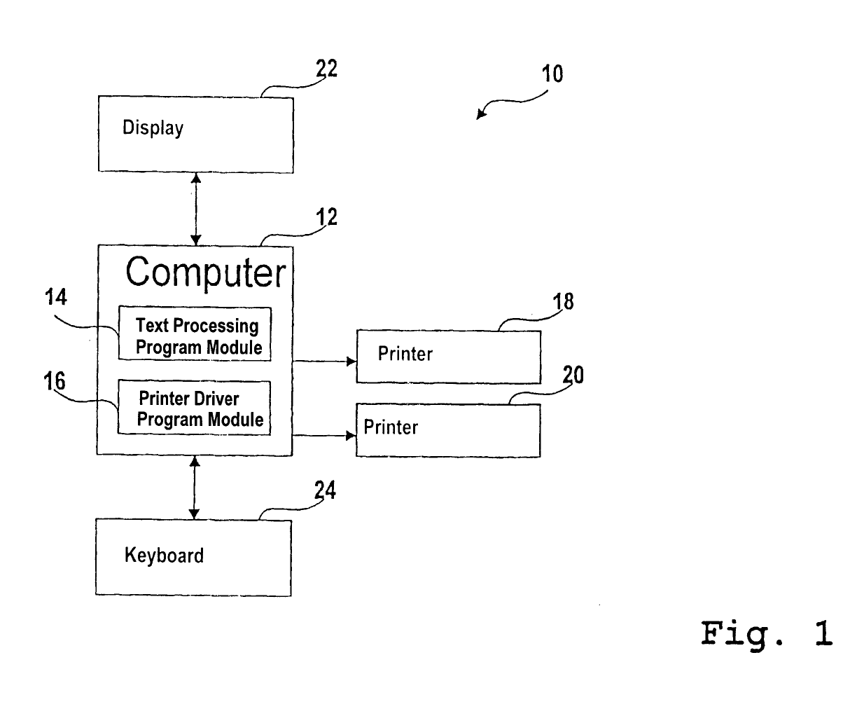

FIG. 1 a computer system with which a print page according to the invention is created, edited and printed out;

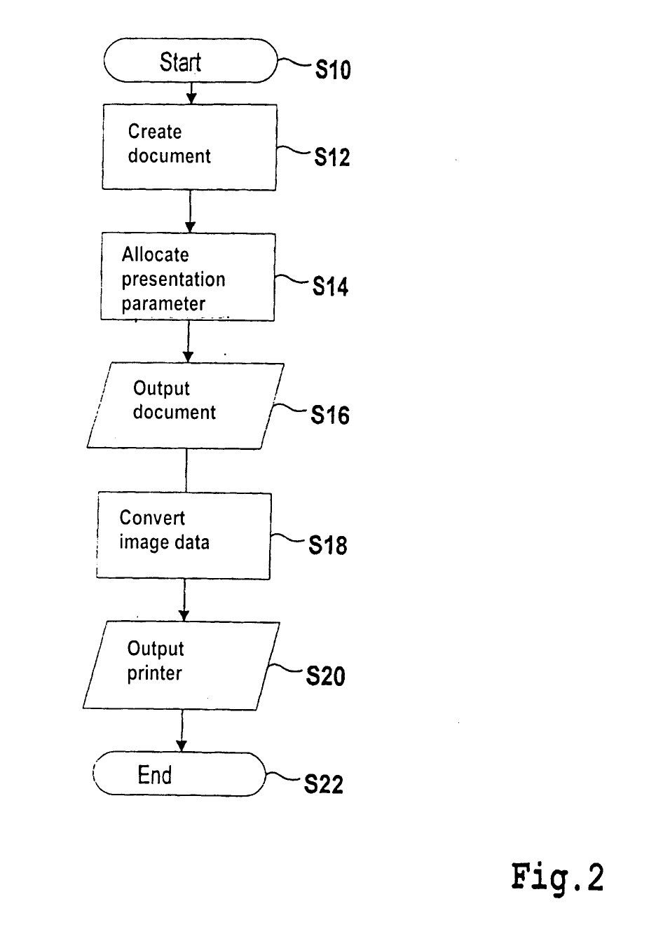

FIG. 2 a flowchart for creating and outputting a print page according to an embodiment of the invention;

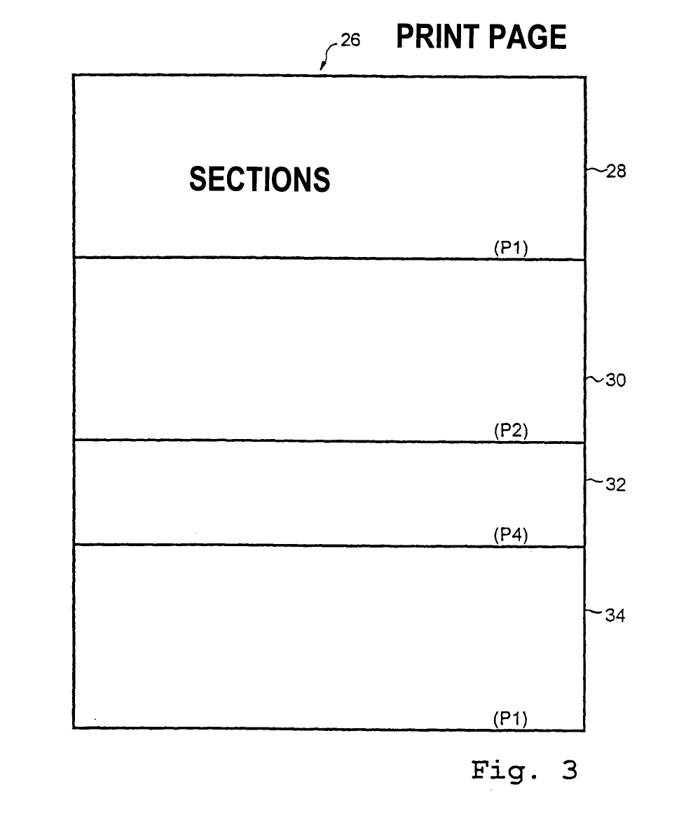

FIG. 3 a print page that is divided into a plurality of sections, whereby a presentation parameter is allocated to each section;

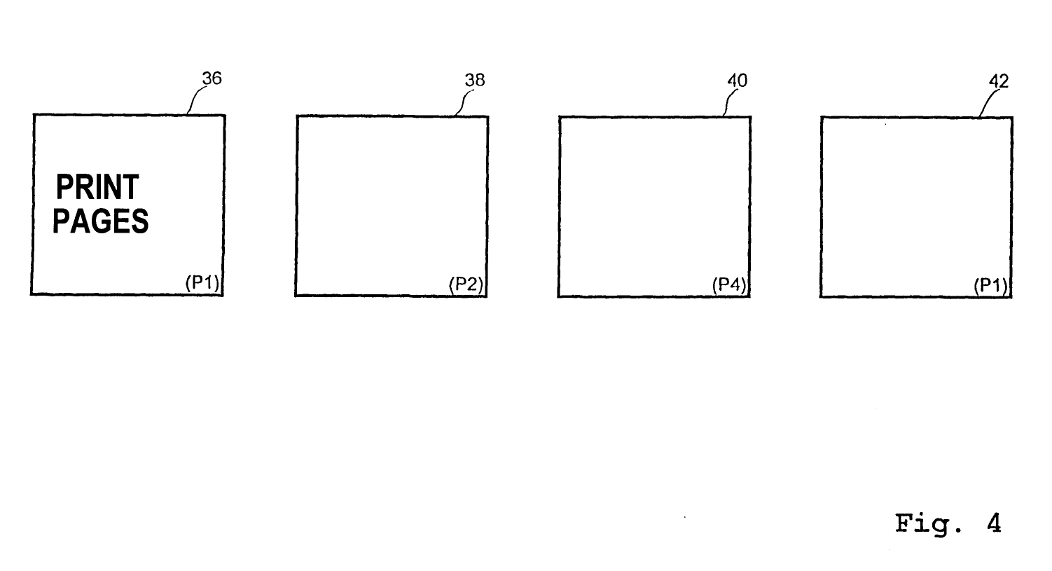

FIG. 4 a plurality of print pages, to each of which a presentation parameter is respectively allocated;

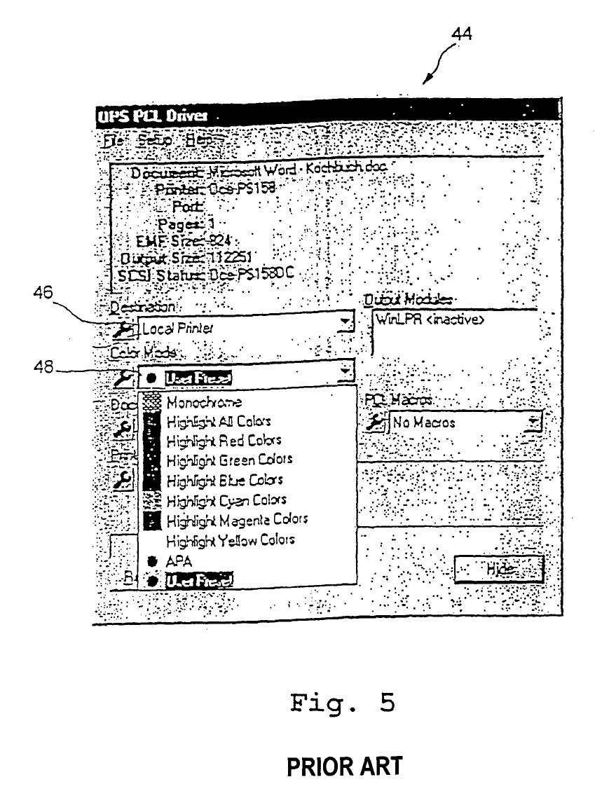

FIG. 5 a form of a printer drive program module according to the Prior Art for pre-setting the output parameters of a printer;

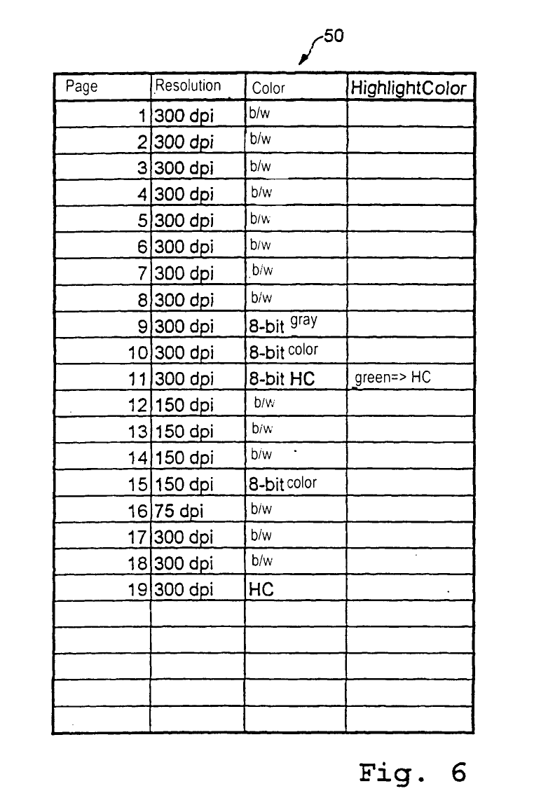

FIGS. 6-8 forms of a printer drive program module according to embodiments of the invention; and

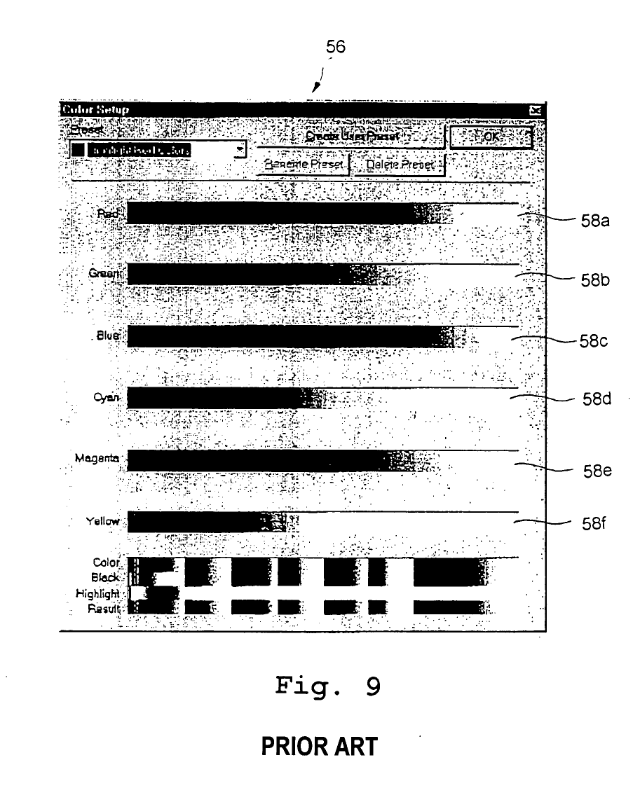

FIG. 9 a further form of a printer driver program module according to the Prior Art for pre-setting the color matching of picture elements to be output.

FIG. 1 shows a computer system 10 with which a print page according to the invention can be created, edited and printed out. A computing unit 12, for example a computer, contains a plurality of program modules, a text processing program module 14 and a printer driver program module 16 thereof being shown. The printer 18 can output print pages with a resolution of 300 dpi black/white. The printer 20 can output print pages with a resolution of 600 dpi in two-color printing, what is referred to as highlight color printing. These operation-conditioned properties of the printers 18, 20 are referred to as output parameters.

Further, the computer 12 is connected to a display unit 22, for example a picture screen, and to an input unit 24, for example a keyboard. The picture screen 22 and the keyboard 24 serve as man/machine interface between an operator (not shown) and the computer 12.

FIG. 2 shows a flowchart for creating and outputting a print page according to an embodiment of the invention. The execution is started in the step S10. In step S12, the operator creates image data of a document containing at least one print page with the assistance of the text processing program module 14. Subsequently, the operator allocates a respective presentation parameter to sections of the document in the step S14. In step S16, the operator gives the command to output the document on the printer 18. In step S18, the image data of the document are converted into second image data with the assistance of the printer driver 16. The first image data are thereby converted such that the second image data are present in the printer language of the printer 18. The printer language can thereby be, for example, a PostScript, PCL or AFP printer language. The printer language is a specific data format in which image data are transmitted to printers 18, 20 and further-processed by the latter. A respective printer driver 16 is present for different printers 18, 20 having different output parameters as well as for different printer types 18, 20. The output parameters of the printer 18 can be pre-set for individual document sections in the inventive printer driver 16, preferably in forms of the printer driver 16. The allocation of the document sections to the pre-set output parameter sets of the printer 18 preferably ensues with the assistance of the presentation parameter allocated to the respective section. Standard parameters such as, for example, the contrast, the brightness, a reduction of the possible output resolution of the printer 18, the paper feed, the paper format and the desired print density can thereby be pre-set for the individual document sections. Given the printer 20, additional settings for the individual sections of the print page are possible for activating the highlight color printing, for pre-setting the desired color mixing and pre-settings for color matching, i.e. presettings that define the color space of the image data that are output, said settings being specified by the respective presentation parameter.

Subsequently, the image data are transmitted to the printer 18 in the PCL printer language. The printer 18 further-processes the image data and, in the step 20, outputs the print image corresponding to the communicated image data on a carrier material, for example on paper. The execution has been ended in step S22.

Given, for example, documents that contain a plurality of print pages, it is possible on the basis of the presentation parameters to allocate a respective presentation parameter that is to be output on the printer 20 to entire print pages. A section thus comprises a full print page. For example, those pages that contain chromatic picture elements can have presentation parameters allocated to them that initiate the printer driver to convert the image data of all picture elements of these pages into the AFP printer language of the printer 20 and to transmit these converted data to the printer 20. The image data of the other print pages are converted into the PCL printer language of the printer 18 according to the respective presentation parameters. As a result thereof, it is possible to output individual print pages of the document on different printers 18, 20 and to thereby allocate different output parameters of the respective printer 18, 20 to individual sections of the print page. The conversion of the image data into the PCL printer language of the printer 18 and the conversion of the image data into the AFP printer language of the printer 20 can thereby also ensue in two different printer drivers. The image data of all print pages are then supplied, for example, to both printer drivers, whereby the printer drivers only further-process the data with presentation parameters to which output parameter sets are allocated in the respective printer driver.

FIG. 3 shows a print page 26 that is divided into a plurality of sections 28, 30, 32, 34, whereby a respective presentation parameter P is allocated to each section 28, 30, 32, 34. The parameter P1 is thereby allocated to the sections 28 and 34, the parameter P2 to the section 20 and the parameter P4 to the section 32. It is likewise possible to provide all of the sections 28 through 32 with the same presentation parameter.

FIG. 4 shows a plurality of print pages 36, 38, 40, 42 to which a respective presentation parameter P is allocated. The presentation parameter P1 is allocated to the entire print page 36 and the print page 42, the presentation parameter P2 is allocated to the print page 38, and the presentation parameter P4 is allocated to the print page 40.

FIG. 5 shows a form 44 of a printer driver program module of the Prior Art wherein an operator can set output parameters that have already been described above.

Via various menus, preferably via what are referred to as pull-down menus (two thereof are referenced 46 and 48), the operator can select a printer 18, 20 that is connected to the computer 12 and can also pre-set the output parameters thereof. When image data are subsequently forwarded to the printer driver, for example by inputting a command of the operator, the printer driver converts these according to the pre-settings into second image data that are then present in the printer language of the selected printer and are forwarded thereto for further-processing.

FIG. 6 shows a form 50 of an inventive printer driver 16. The form 44 of the printer driver of the Prior Art shown in FIG. 5 is contained in the printer driver 16 in addition to the form 50 shown in FIG. 6, so that all setting possibilities of the Prior Art are also contained in the inventive printer driver. Further forms with further setting possibilities of the Prior Art are also conceivable in the inventive printer driver 16. The form 50 has a tabular form, whereby the page numbers of the document to be printed out are entered in the left-hand column. The output parameters of resolution, color and color allocation (highlight color) are assigned to each page in the respective row of the table. The output parameters allocated to the respective page form an output parameter set that contains prescriptions to which the second image data correspond in the output on the selected printer after being created from the first image data. Further output parameters that can be allocated to the corresponding page are conceivable.

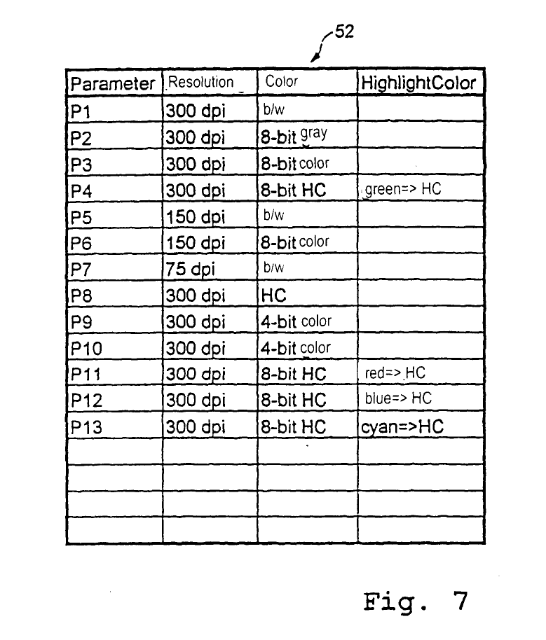

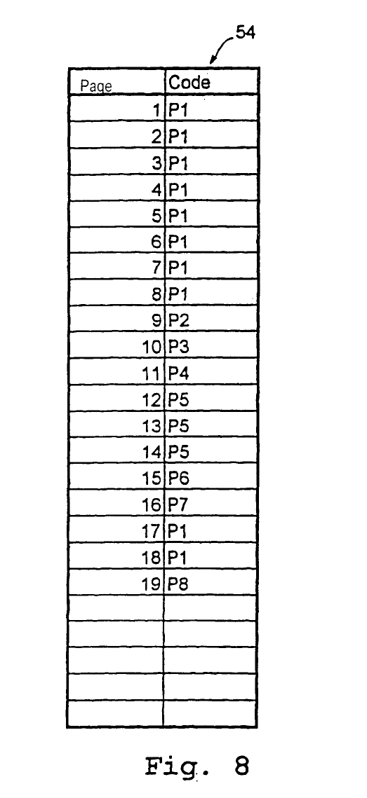

FIGS. 7 and 8 show two forms 52, 54 of a further inventive printer driver that are contained in the printer driver instead of or in addition to the form 50 from FIG. 6. Presentation parameters P1 through P13 that are arranged in the first column of the form 52 are thereby defined in the form 52. The output parameters are entered in each row of the table, as in the form 50 from FIG. 6, but these are allocated to the presentation parameters P1 through P13 instead of to the pages 1 through 19. The presentation parameters P that are defined in the form 50 are allocated to the form 54 of FIG. 8. Compared to the form 50, the forms 52 and 54 have the advantage that only the presentation parameters P1 through P13 need be allocated to the pages in the form 54. The definition of the presentation parameters P1 through P13 thus need be defined only once even for the output of different documents. The allocation of the presentation parameters P1 through P13 to the pages of the document ensues individually for each document. The plurality of presentation parameters P the operator can define is thereby not limited.

FIG. 9 shows a further form 56 of a printer driver program module for presetting the color matching of picture elements to be output. Such forms for color matching are known in the Prior Art. These color settings were defined for the output of an entire document. Different settings of these output parameters for the color presentation of picture elements to be output and that also describe the color space of the picture elements to be output can be allocated to a presentation parameter P together with further output parameters given an inventive printer driver. Due to the allocation of different presentation parameters P to sections of the document, different presentation variations and effects as well as different effects of the picture elements that are output can be achieved in the output on the selected output unit 18. Given the illustrated form 56, the intensity with which each of the displayable colors is taken into consideration in the conversion of the image data is defined with the assistance of of setting scales 58a through 58f. The pre-settings can ensue individually for each section with the inventive printer driver. Further setting possibilities are possible, particularly for defining and adapting the color space. These adaptations are particularly needed when the colors of the picture elements to be presented are reduced to the colors of the output unit or, respectively, are output with the existing colors of the output unit.

Embodiments are also conceivable wherein a plurality of presentation parameters P are allocated to each section of the document. One presentation parameter P can thereby determine the settings of the color matching and color conversion and a further presentation parameter P can determine the settings for adapting the resolution of the picture elements. Further presentation parameters P as well as further combinations of pre-settings are possible.

It is also advantageous to automatically allocate a presentation parameter P to the respective section of the document. For example, the sections of the documents can be searched for predetermined characters strings, particularly for predetermined words. Given agreement of words of a searched section, a corresponding presentation parameter P is automatically allocated to this section with the assistance of a logical operation.

The invention is employed both for creating documents as well as for outputting documents. Further, the invention can also be used in a method for creating and outputting documents.

In the method for creating a document, the document that contains first image data of picture elements is created with the assistance of a creation program module. A respective presentation parameter P is allocated to the sections of the document. With the assistance of the presentation parameter P, an image processing procedure 30 with which the image data are converted into second image data is automatically selected in an output system at a much later time, said second image data corresponding to the output parameters of an output unit, for example of a printer 18, 20, selected in the output parameters.

### LIST OF REFERENCE CHARACTERS

10 computer system

12 first computer

14 text processing program module

16 printer driver program module

18, 20 printer

22 picture screen

24 keyboard

26 print page

28-34 sections of a document

36-42 print pages

44 forms (register cards) of the printer driver

46, 48 pull-down menu

50-56 forms (registers cards) of the printer driver

58a-58f setting scales

P1-P13 presentation parameters

S10-S22 executive sequence steps

1. Method for creating and/or outputting a document,
whereby the document is produced with the assistance of a creation program module (14),
the document contains first image data of picture elements, whereby sections (28, 30, 32, 34) of the document have a respective presentation parameter P allocated to them that defines an output parameter set,
an output unit (18, 20) outputs picture elements on the basis of second image data, the image properties of said picture elements being defined by this output parameter set,
a drive program module (16) for driving the output unit (18, 20) generates second image data corresponding to the output parameter set of the output unit (18, 20) from the first image data section by section (28, 30, 32, 34),
and whereby the presentation parameter P defines a selection of output parameters from a plurality of possible output parameters for this output unit (18, 20).

2. Method according to claim 1, characterized in that the document comprises a plurality of print pages (36, 38, 40, 42); and in that the allocation of the presentation parameters P ensues page-by-page.

3. Method according to claim 1 or 2, characterized in that the output unit (18, 20) is a printer; and in that the drive program module (16) is a printer driver.

4. Method according to one of the preceding claims, characterized in that the sections (28, 30, 32, 34) of the document are output on different output units (18, 20) dependent on the presentation parameter P, whereby the output unit (18, 20) and the output parameters are automatically selected with the assistance of the presentation parameter P.
Method according to one of the preceding claims, characterized in that the presentation parameter P is defined during the creation of the document.

6. method according to one of the preceding claims, characterized in that a document that is independent of the output parameters of the output unit is created with the assistance of the creation program module (14).

7. Method according to one of the preceding claims, characterized in that the sections (28, 30, 32, 343) of the document contain graphics elements such as text, vector graphics, business graphics, images, tables, landscape photos and/or portrait photos.

8. Method according to one of the preceding claims, characterized in that the output parameters contains the resolution, the color depth, the color space and the output medium of the output unit (18, 20).

9. Method according to one of the preceding claims, characterized in that the creation program module (14) is a text processing program module, a DTP program module or a forms generator.

10. Method according to one of the preceding claims, characterized in that the creation program module (14) and the drive program module (16) are processed in separate computing units (12) of a data processing system (10).

11. method according to one of the preceding claims, characterized in that two respective presentation parameters P are allocated to the sections (28, 30, 32, 34) of the document.

12. Method according to one of the preceding claims, characterized in that the presentation parameters P are automatically allocated with the assistance of of data contained in the sections (28, 30, 32, 34).

13. Method according to claim 12, characterized in that the text of each and every section (28, 30, 32, 34) is searched for predetermined character strings; and in that a corresponding presentation parameter P is allocated to this section (28, 30, 32, 34) with the assistance of identified, coinciding character strings.

14. Computer software, comprising commands and data in encoded form that, after the loading of the computer software, initiate a computer system, characterized in that [...] to execute the steps cited in one of the claims 1 through 13.

15. Computer software according to claim 14, [...] it is stored on a storage medium.

16. System for creating and/or outputting a document,
whereby the document is produced with the assistance of a creation program module (14),
the document contains first image data of picture elements, whereby sections (28, 30, 32, 34) of the document have a respective presentation parameter P allocated to them that defines an output parameter set,
an output unit (18, 20) outputs picture elements on the basis of second image data, the image properties of said picture elements being defined by this output parameter set, a drive program module (16) for driving the output unit (18, 20) generates second image data corresponding to the output parameter set of the output unit (18, 20) from the first image data section by section (28, 30, 32, 34),
and whereby the presentation parameter P defines a selection of output parameters from a plurality of possible output parameters for this output unit (18, 20).
